(19) United States
(12) Patent Application Publication
(10) Pub. No.: US 2007/0110988 A1
(43) Pub. Date: May 17, 2007

(54) Inorganic layer

(76) Inventors: Olaf Binkle, Kirkel (DE); Ralph Nonninger, Saarbrucken (DE)

Correspondence Address: Walter A Hackler;Patent Law Office, Suite B, 2372 S E Bristol Street, Newport Beach, CA, 92660-0755, US

(21) Appl. No.: 10/545,018

(22) PCT Filed: Nov. 19, 2003
(86) PCT No.: PCT/DE03/03832

§ 371 Date: Nov. 18, 2005

(30) Foreign Application Priority Data
Feb. 11, 2003 (DE) 103 05 866.4

(51) Int. Cl. B32B 3/00; C04B 33/32; B32B 3/26

(52) U.S. Cl. 428/312.2; 264/628; 264/650

(57) ABSTRACT

In a method for producing a structured inorganic layer (1), in particular, a ceramic layer, a structure is introduced on the surface of a green layer through mechanical processing, and the green layer is subsequently sintered. This procedure permits precise control of the position and dimensions of the structures.

### BACKGROUND OF THE INVENTION

The invention concerns an inorganic layer and a method for its production.

A layer of this type is disclosed e.g. in DE 43 29 473 C1.

One surface of the conventional inorganic layer comprises grooves having a semi-circular cross-section. The inorganic layer is porous and can be used as filtering layer. The differential pressure can be absorbed without producing tensile stresses in the layer due to the semi-circular shape of the grooves. In particular, channels for collecting filtered matter are formed by connecting two conventional porous structured inorganic layers to each other. However, these channels are open on both sides. One side must be closed, in particular, made desolated to form a filter module. This document does not describe a method for producing the inorganic layer.

### OBJECT OF THE INVENTION

It is the object of the present invention to provide a method for producing a structured inorganic layer, and present an inorganic layer which is easy to produce.

### SUMMARY OF THE INVENTION

This object is achieved in accordance with the invention by a method for producing a structured inorganic layer, in particular, a ceramic layer, wherein a structure is introduced on a green layer surface through mechanical processing and subsequent sintering of the green layer. A green layer is a layer which contains particles, in particular, ceramic particles and can be sintered into a porous or dense layer. A green layer can be readily mechanically processed so that almost any structure can be introduced into the surface of the layer. These introduced structures are solidified by sintering.

In a particularly preferred manner, the structure is introduced through milling, laser cutting or embossing. Milling is especially advantageous if the inorganic layer is to be used as filtering layer. In contrast to embossing, wherein material is displaced, milling is performed by removing material. Areas of the green layer are not compacted before sintering with the result that a homogeneous green layer remains which can be uniformly compacted during sintering. This can prevent inhomogeneities which would disturb the filtering process. If mechanical processing is performed by milling, it is possible to generate very small structures or grooves, in particular, with free cross-sections <0.4 mm. The layers produced in this manner may be particularly light and small. If processing is performed by milling, grooves of any cross-section can be formed and the arrangement of the groove in the surface of the inorganic layer can be freely selected.

In a preferred method variant, one or more groove-like structures are introduced. Cavities and channels for discharging filtered matter can be formed by the groove-like structures, in particular, through connection with other similar inorganic layers.

In a particularly preferred manner, the groove-like structure is introduced such that it terminates at least at one end in the green layer. Channels which are closed at one end are produced through covering a surface of such a structure with another layer. The tubular channels need not be additionally closed as is required in prior art.

In a preferred method variant, the groove-like structure is introduced such that the other end of the groove-like structure terminates in another groove-like structure or terminates in one side of the green layer. If the groove-like structure terminates in another groove-like structure, it is possible to form collecting structures, e.g. for filtered matter. Several groove-like structures which, through cooperation with another layer form channels, require only a few, in particular one outlet opening for filtered matter on the structure. This geometry can be obtained only through mechanical processing of the green layer. If the groove-like structure terminates in the side of the layer, a collecting channel can be connected directly to a groove or, if the groove is turned into a channel through covering with another layer, be connected to the channel. This embodiment permits simple and secure sealing between the channel leaving the layer and the collecting channel.

In a particularly preferred manner, a fan-like structure is introduced. The grooves can thereby be oriented towards a collecting channel and discharge of the filtered matter can be accelerated.

In a further embodiment of the method, the green layer is produced through foil casting or extrusion. In particular, if the green layer is produced through foil casting, the inorganic layer can be produced to have almost any geometrical shape. If a first and a second green layer are connected before introduction of the groove-like structure, wherein at least one of the layers is structured, the properties of the layer, in particular, its filtering properties can be influenced through selection of different materials in the layers or different particle sizes in the layers. The particles may thereby have different shapes. They may e.g. be spherical, have the shape of small plates or fibers. The porosity of the inorganic layer can be influenced by appropriate selection of the particle size. If the green layer is produced through extrusion, the structure can be introduced into the surface of the layer during extrusion.

The ceramic materials used in the green layers are preferably derived from (mixed) metal oxides and carbides, nitrides, borides, suicides and carbonitrides of metals and non-metals. Examples thereof are Al₂O₃, partially and completely stabilized ZrO₂, mullite, cordierite, perovskite, spinels, e.g. BaTiO₃, PZT, PLZT and SiC, Si₃N₄, B₄C, BN, MoSi₂, TiB₂, TiN, TiC and Ti(C,N). It is clear that this list is incomplete. It is of course also possible to use mixtures of oxides or non-oxides and mixtures of oxides and non-oxides.

In a preferred further embodiment of the method, the first layer is sintered into a carrier layer having coarse pores and the second layer is sintered into a functional layer having fine pores. The fine-pored functional layer thereby represents the filtering layer. The carrier layer having coarse pores supports the fine-pored functional layer. The groove-like structures are formed in the support layer. After sintering, a stack of layers, respectively a ceramic compound is obtained.

Channels for discharging filtered matter can be realized in a particularly simple manner by laminating the structured surfaces of two green layers or stacks of layers. The groove-like structures may thereby be formed only on the surface of one layer or on the surfaces of both layers. The layers may be connected such that the groove-like structures are offset or disposed opposite to each other. If they are opposite to each other, channels having a large cross-section are formed in the stack of layers obtained.

The invention also involves an inorganic layer, in particular, a ceramic layer, with at least one groove-like structure formed on a surface, wherein the structure terminates in the layer at one end. A channel which is closed on one side is produced by connecting a layer of this type to another layer which covers the groove-like structure. In contrast to prior art, the channel end must not be closed later.

In a preferred embodiment, the other end of the groove-like structure terminates on one side of the layer. If the groove-like structure is covered, the end on the side of the layer represents an outlet opening which can be connected e.g. to a channel for collecting filtered matter.

In an alternative embodiment, the other end of the groove-like structure terminates in a depression, in particular, a different groove-like structure which permits combination of several groove-like structures in one common groove.

In one embodiment of the invention, the groove-like structure has a U-shaped or rectangular or polygonal cross-section.

In a particularly advantageous manner, the layer is formed as porous layer. The layer may then be used as filter element and the groove-like structures can be used as structures for collecting filtered matter.

In an advantageous embodiment, at least one fine-pored layer and one coarse-pored layer are provided, wherein the coarse-pored layer is structured. The coarse-pored layer may be used as carrier layer for the fine-pored functional layer which is the actual filtering layer. The carrier increases the stability of the entire stack of layers. In a preferred embodiment, the structured surface of the layer is fixed to another layer. Channels are formed between the structured surface and the other layer due to the groove-like structures. These channels can be used as channels for discharging filtered matter, in particular, if the layers are porous layers. The interconnected layers may have the same or a different porosity and the same or a different thickness.

In a preferred further development, also the other layer is structured on one surface thereof and the two structured surfaces are fixed to each other. This measure permits generation of channels for discharging filtered matter having a large cross-section. The channels for discharging filtered matter of this type are closed at one end if groove-like structures, one end of which terminates in the layer, are introduced into the structured surfaces. The forms of the recesses obtained by structuring can be disposed to coincide or be mutually offset when two layers are joined.

The channels formed between the layers can, in principle, have any cross-section. However, channels having a square, rectangular or polygonal cross-section are particularly preferred.

In a particularly preferred manner, the channels are joined in the layer or in the stack of layers and have a common outlet opening. In particular, for producing filter elements from the layers, the filtered matter discharged in the discharge channels for filtered matter can be removed from the filter element through a common outlet opening which permits simple connection to a channel for collecting filtered matter.

The layer may have almost any feasible geometrical shape. In a particularly preferred manner, the layer or the stack of layers has a cuboid or cylindrical shape.

It is possible to realize very small and light filter elements with a minimum amount of material if the filter elements formed from the layers have very fine structures which can be readily produced through milling of the layers.

Further features and advantages of the invention can be extracted from the following description of embodiments of the invention, the figures of the drawing which show details which are essential to the invention, and from the claims. The individual features can be realized either individually or collectively in arbitrary combination in a variant of the invention.

### BRIEF DESCRIPTION OF THE DRAWING

The schematic drawing shows embodiments of the inventive inorganic layer which are explained in the following description.

FIG. 1 shows a plan view of an inorganic layer with groove-like structures;

FIG. 2 shows a cross-section through an inorganic layer with groove-like structures;

FIG. 3 shows a cross-section through an inorganic layer with groove-like structure having another cross-section;

FIG. 4 shows two layers in accordance with FIG. 3 in the joined state;

FIG. 5 shows a perspective view of a stack of layers having channels in its inside.

### DESCRIPTION OF THE PREFERRED EMBODIMENT

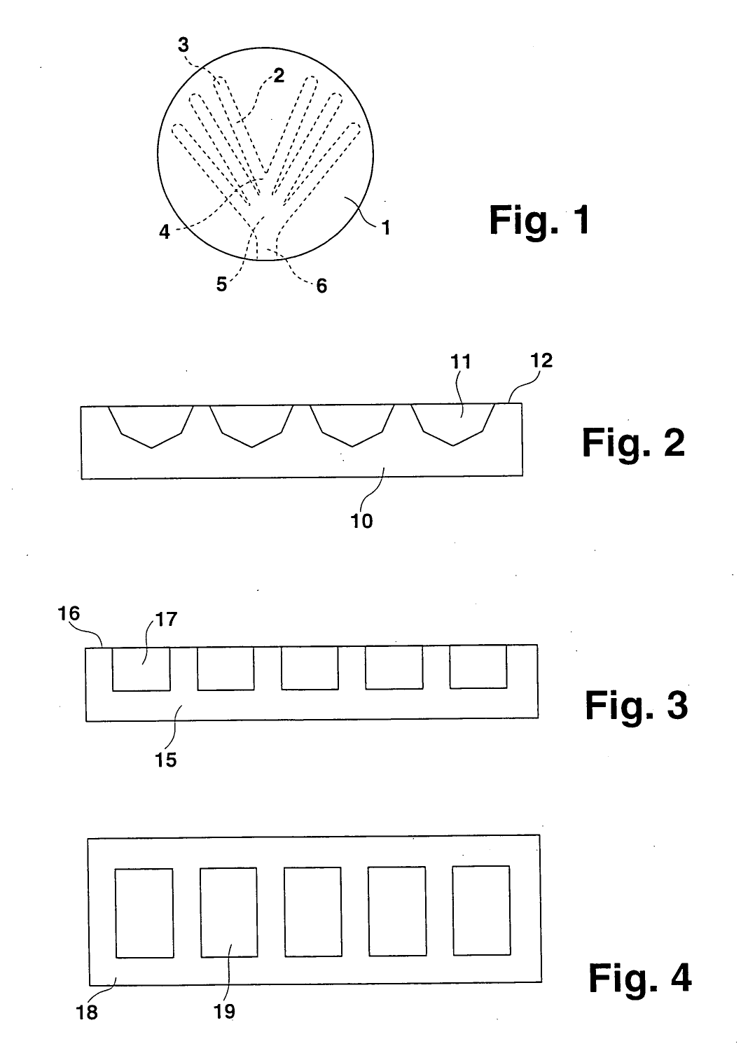

FIG. 1 shows a plan view of an inorganic layer 1, whose surface is provided with groove-like structures 2 in the form of a fan. The groove-like structures 2 terminate at one end 3 in the inorganic layer 1. The other end 4 of the groove-like structures 2 terminates in a depression 5, wherein the depression 5 may be deeper than the groove-like structures 2. The groove bottom of the groove-like structures 2 may be flush with the bottom of the depression 5. The depression 5 terminates in one side 6 of the inorganic layer 1.

FIG. 2 shows a cross-section through an inorganic layer 10 into which parallel extending groove-like structures 11 were introduced through milling, wherein the groove-like structures 11 have a pentagonal cross-section. Channels having an octagonal cross-section are obtained by connecting the structured surfaces 12 of two inorganic layers 10 of this type to each other.

FIG. 3 shows a section through an inorganic layer 15, wherein the surface 16 comprises groove-like structures 17 which have a rectangular cross-section.

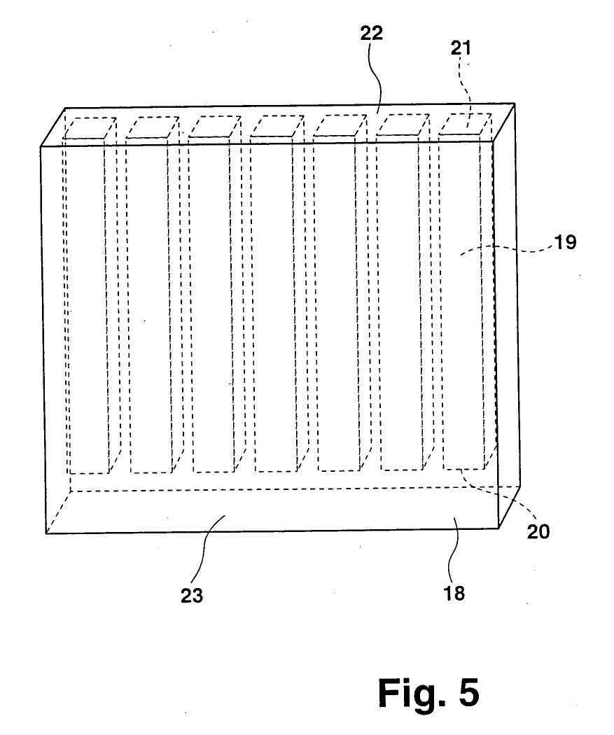

FIG. 4 shows a cross-section through a stack of layers 18 which is produced from two layers 15 in accordance with FIG. 3. Towards this end, the structured surfaces of two inorganic layers are connected to each other thereby forming channels 19 having a rectangular cross-section. After sintering, the stack of layers 18 exhibits a layer with internal channels.

FIG. 5 shows a perspective view of the stack of layers 18 of FIG. 4. The stack of layers 18 has a cuboid shape and comprises channels 19 formed as filtered matter discharge channels in the embodiment. One end 20 of the channels 19 terminates in each case in the stack of layers 18. The opposite end 21 terminates in one side 22 of the stack of layers 18. These ends 21 can be connected to a collecting channel which is not shown. Since the ends 20 terminate in the stack of layers 18 and are separated from the side 23 opposite to the side 22, the channels 19 need not be specially closed at one end. The stack of layers 18 is suited for use as filter element since the inorganic layers 15 (FIG. 3) are porous. Liquid to be filtered is collected on the outside of the stack of layers 18 and, due to a pressure difference, flows into the channels 19 from which the filtered matter is discharged via the ends 21 of the channels 19.

In a method for producing a structured, inorganic layer 1, in particular, a ceramic layer, a structure is introduced on the surface of a green layer through mechanical processing, and the green layer is subsequently sintered. Two or more layers can be laminated and be commonly sintered before the sintering process. This method provides exact control of the-position and dimensions of the structures.

We claim:

1. Method for producing a stack of layers comprising structured inorganic layers (1, 10), in particular ceramic layers, wherein a structure is introduced on one of the surfaces (16) of a green layer through mechanical processing and the green layer is subsequently sintered, wherein one or more groove-like structures (2, 11, 17) are introduced, and the groove-like structure (2, 11, 17) is introduced in such a manner that at least one end thereof terminates in the green layer, wherein the green layer is produced through foil casting or extrusion, characterized in that two green layers or stacks of layers are laminated to each other on the structured surface (12) thereby forming channels which are closed at one end, and the groove-like structure (2, 11, 17) is introduced in such a manner that the other end (4) of the groove-like structure terminates in one side of the green layer.

2. Method according to claim 1, characterized in that the structure is introduced through milling or laser cutting or embossing.

3. Method according to claim 1, characterized in that a fan-like structure is introduced.

4. Method according to claim 1, characterized in that a first and a second green layer are interconnected before introducing the groove-like structure, wherein at least one of the layers is structured.

5. Method according to claim 4, characterized in that the first layer is sintered into a coarse-pored carrier layer and the second layer is sintered into a fine-pored functional layer.

6. Inorganic stack of layers (1, 10) comprising a layer, in particular a ceramic layer, with at least one groove-like structure (2, 11, 17) formed on a surface (16), wherein one end of the structure terminates in the layer (1, 10), wherein the layer is made from a green layer produced through foil casting or extrusion, and another inorganic layer, in particular a ceramic layer, characterized in that the structured surface (12) of the layer is fixed to the other layer thereby forming channels which are closed at one end, and the other end (4) of the groove-like structure terminates on one side (22) of the layer (1, 10).

7. Stack of layers according to claim 6, characterized in that the groove-like structures (2, 11, 17) have a U-shaped or rectangular or polygonal cross-section.

8. Stack of layers according to claim 6, characterized in that the layer (1, 10) is formed as porous layer.

9. Stack of layers according to claim 8, characterized in that a fine-pored layer and a coarse-pored layer are provided, wherein the coarse-pored layer is structured.

10. Stack of layers according to claim 6, characterized in that the other layer is structured on one surface (16) and the two structured surfaces are fixed to each other.

11. Stack of layers according to claim 6, characterized in that the channels are joined in the layer and have a common outlet opening.

12. Stack of layers according to claim 6, characterized in that the layer is cuboid or cylindrical, in particular disc-shaped.
